(19) United States
(12) Patent Application Publication
(10) Pub. No.: US 2008/0195649 A1
(43) Pub. Date: Aug. 14, 2008

(54) Dynamic User Interface and a Method For Generating a Dynamic User Interface For Interfacing With an Electronic Data Repository Storing a Collection of Data Elements

(76) Inventor: Jacques Marie Yann Etienne Lefebvre, Wicklow (IE)

Correspondence Address: SUGHRUE MION, PLLC, 2100 PENNSYLVANIA AVENUE, N.W., SUITE 800, WASHINGTON, DC, 20037, US

(21) Appl. No.: 11/910,807

(22) PCT Filed: Apr. 10, 2006
(86) PCT No.: PCT/IE2006/000029

§ 371 Date: Nov. 26, 2007

(30) Foreign Application Priority Data
Apr. 8, 2005 (IE) S2005/0208

(51) Int. Cl. G06F 17/30

(52) U.S. Cl. 707/102; 707/E17.005

(57) ABSTRACT

A system (2) is provided for generating a dynamic user interface (1) in the form of a graphical user interface display on a visual display unit (8) of a computer (3) for facilitating interfacing with an electronic data repository storing a collection of data elements on a remote magnetic hard disc drive (4). A CD-ROM (6) containing a set of rules is installed on the computer (3). The computer (3) in response to the set of rules extracts the meta-data describing the data elements in a data model from the remote magnetic hard disc drive (4) and saves on a local hard disk (10) tabulated. The extracted meta-data is then processed which enables the computer (3) to generate a meta model. The computer (3) generates the dynamic user interface (1) based on the meta model for providing a visually perceptible representation of the meta model.

The present invention relates to a dynamic user interface and a method for generating a dynamic user interface for facilitating interfacing with an electronic data repository storing a collection of data elements.

It is desirable that data stored in an electronic data repository be easy to access, interpret and manipulate. As the volume of data stored increases, the accessing, interpretation and manipulation of the data becomes more difficult. In electronic data bases such as computer databases data is stored in a data repository as data elements in a series of tables. In order to facilitate accessing, interpretation and manipulation of the data elements, a data model is provided by a software application that classifies the data elements in a plurality of hierarchical data structures. Data elements beneath other data elements in the hierarchical data structures are categorised as being attributes of other data elements at the top of the corresponding hierarchical data structure. The data model is defined using a meta data description, data models of this type will be will known to those skilled in the art.

Data models traditionally have been written to be industry specific and tailored to suit specific departments of a business organisation, for example, the sales sector, finance sector, marketing sector and the like. The data model for each sector arranges the hierarchical data structures differently, often using the same data elements. For example, the data elements in a data model for the sales sector positions data elements relating to sales at the top the hierarchical data structures, while the data elements in a data model for marketing positions the data elements relating to marketing at the top the hierarchical data structure. When data elements are being retrieved from the database the appropriate data model must be adhered to which severely limits how the data is retrieved and presented.

In order to retrieve data from a database it is necessary to interface with the database. One common method of interfacing with a database is the use of Structured Query Language (SQL) scripts for generating a query for extracting the required data. Creating query language scripts requires programming skill and knowledge, thus, retrieving data from a database is not a trivial matter. Software tools have been developed which generate a user interface for aiding the user to query a database without the need for the user to be skilled in a query language. However, these tools have many disadvantages. In general the user interfaces generated from such tools are written to comply with a particular data model with its functionality hard coded, and thus, such user interfaces lack flexibility in the manner in which they permit the retrieval and presentation of data elements, and in general, are not adaptable to changes to the underlying database. Accordingly, hard coded user interfaces require constant maintenance by a computer programmer to keep the user interface up to date for reflecting the latest version of the database, such maintenance is expensive and very time consuming often resulting in a substantial amount of downtime during which the user interface is not fully functional.

There is therefore a need for a dynamic user interface for interfacing with an electronic data repository storing a collection of data elements that overcomes at least some of the disadvantages of the prior art.

The present invention is directed towards providing such a user interface.

According to the invention there is provided a method for generating a dynamic user interface for facilitating interfacing with an electronic data repository in which a collection of data elements is stored, the method comprising extracting meta data from an existing data model describing the data elements stored in the data repository, processing the extracted meta data in accordance with a predefined set of rules to generate a meta model, and generating the dynamic user interface based on the meta model.

In one embodiment of the invention the set of rules comprises instructions for tabulating the extracted meta data and storing the tabulated extracted meta data.

In another embodiment of the invention the meta model comprises definitions for producing a visually perceptible representation thereof for displaying on a visual display screen.

In one embodiment of the invention the dynamic user interface is populated with data elements.

In another embodiment of the invention the set of rules comprises instructions for generating a list of identities of tables containing the data elements in the data repository not represented in the data model.

In one embodiment of the invention the set of rules comprises instructions for displaying the list of the identities of tables on a visual display screen for facilitating selection of tables therefrom in response to instructions from a data input device.

In another embodiment of the invention the meta model is responsive to identities selected from the list of identities of tables.

In one embodiment of the invention the set of rules comprises instructions for generating a meta data description of each table in the data repository corresponding to the identity selected from the list of identities of tables based on an inherent description of the respective table in the data repository.

In another embodiment of the invention the generated meta data description is incorporated into the meta model for facilitating interfacing with data elements in the data repository not represented in the data model.

In one embodiment of the invention the set of rules comprises instructions for adapting the user interface to permit reading data elements from the data repository.

In another embodiment of the invention the set of rules comprises instructions for adapting the user interface to permit writing data elements to the data repository.

In one embodiment of the invention the meta model represents data elements written to the data repository.

In another embodiment of the invention the meta model represents new data elements being entered to the data repository.

In one embodiment of the invention the meta model is responsive to the visually perceptible representation being modified.

In another embodiment of the invention the set of rules comprises instructions for defining a query for interrogating the data repository.

In one embodiment of the invention the query is based on the relationships between tables of the data model.

In another embodiment of the invention the query is translated into a structured query language statement to query the data repository.

In one embodiment of the invention if the query relates to tables of more than one data repository the structured query language statement is broken down into sub structured query language statements that target the corresponding data repository. In another embodiment of the invention the set of rules comprises instructions for creating a communication link for the user interface to the data repository.

In one embodiment of the invention the set of rules comprises instructions for providing a security means associated with the communication link, the security means being responsive to an authorisation code for controlling access to the data elements to the data repository.

In another embodiment of the invention the meta model is indicative of the communication link.

In one embodiment of the invention the meta model is responsive to the authorisation code for defining different levels of access to the data repository.

In another embodiment of the invention the set of rules comprises instructions for defining filters in response to the authorisation code for filtering the data elements in the data repository.

In one embodiment of the invention the set of rules comprises instructions for generating a definition of a hierarchy of tables.

In another embodiment of the invention the set of rules comprises instructions for displaying a hierarchy menu representation of the hierarchy of tables.

In one embodiment of the invention the dynamic user interface facilitates selection of tables from the hierarchy menu representation.

In another embodiment of the invention the data model is defined by a software application associated with the data repository.

In one embodiment of the invention the set of rules is stored on a readable storage medium. Advantageously, the readable storage medium is communicable with a computing means for instructing the computing means to operate in a predetermined manner.

In another embodiment of the invention the set of rules comprises instructions for defining the connections parameters between the computing means and the data repository.

In one embodiment of the invention the set of rules comprises instructions for saving the connection parameters on the computing means.

In one embodiment of the invention the set of rules comprises instructions for defining menu groups, list of values, and a plurality of meta tables comprising attributes and relationships defined for the data elements in the data repository.

In one embodiment of the invention the set of rules comprises instructions for displaying a list page to view and interact with data elements in the data repository based on the meta data stored in the meta model. Advantageously, the list page is displayed on a meta table.

In another embodiment of the invention the set of rules comprises instructions for displaying a page based on corresponding meta tables.

In one embodiment of the invention the set of rules comprises instructions for displaying the list page based on the query.

In another embodiment of the invention the set of rules comprises instructions for processing navigation requests.

In one embodiment of the invention the dynamic user interface comprises a command means for relaying instructions to the computing means.

In another embodiment of the invention the computing means is instructed to initiate a connection to the data repository for creating the communication link between the data repository and the computing means.

In one embodiment of the invention the dynamic user interface comprises at least one display page.

In another embodiment of the invention the display page comprises a generic template.

In one embodiment of the invention the computing means generates a menu group meta table for storing menu groups.

In another embodiment of the invention the computing means generates a list of value meta table for storing list of values.

In one embodiment of the invention the menu groups are stored in the menu group meta table.

In another embodiment of the invention the list of values are stored in the list of values meta table.

In one embodiment of the invention the computing means associates a meta table's properties to a list of values.

In another embodiment of the invention the computing means stores definitions of relationships between tables of the data model.

In one embodiment of the invention the computing means is operable to create multiple communications links.

In another embodiment of the invention the computing means defines a multiple query based on a plurality of tables of the data model. Advantageously, the tables may be stored on multiple data repositories.

In one embodiment of the invention the computing means defines a main table in the data model for creating the query. Advantageously, the computing means defines a sub-table in the data model for creating the query comprising relationship definitions to and from the main table.

In one embodiment of the invention the meta data describes at least one of query's meta table, report's meta table and data element's meta table.

In one embodiment of the invention the dynamic user interface creates a display page for viewing data elements.

In another embodiment of the invention the dynamic user interface creates an entry page for entering data elements.

In one embodiment of the invention the dynamic user interface displays related tables of the data model to the selected meta table.

In another embodiment of the invention the set of rules comprises instructions for creating menus.

In one embodiment of the invention for each menu group associated to the user in the meta model a root item is created in a tree structure which represents the main menu of the dynamic user interface.

In another embodiment of the invention the rules comprises instructions for determining if the is able to see tables. Advantageously, for each table that the user has access to, an item is created in the tree structure as a child of the menu group item that the table is attached to, or as a root item if no menu group is attached.

In one embodiment of the invention if the user is not able to see tables, the rules comprises instructions for determining if the user is able to see queries. Advantageously, if the user is able to see queries for each query that belongs to the user or is public and that the user has access to an item is created in the tree structure as a child of the menu group item that the query is attached to, or as a root item if no menu group is attached.

In another embodiment of the invention the rules comprises instructions for determining if the user is able to see reports. Advantageously, if the user is able to see reports for each report that belongs to the user or is public and that the user has access to an item is created in the tree structure as a child of the menu group item that the report is attached to, or as a root item if no menu group is attached.

In a further embodiment of the invention the rules comprises instructions for displaying the main menu.

In one embodiment of the invention the dynamic user interface creates a list display page when it receives a request to see a list display page for a given table from the table hierarchical menu.

In a further embodiment of the invention the list display page comprises a list display template associated to the table.

In one embodiment of the invention the list display page comprises a user-preferred template.

In another embodiment of the invention the dynamic user interface is operable in a list mode.

In one of the invention the dynamic user interface is operable to select an attribute from the table.

In another embodiment of the invention if the selected attribute is visible in the list mode, the dynamic user interface adds a first column to the list display template with the appropriate column type.

In one embodiment of the invention if the selected attribute is a file or a world wide web URL or a pointer to an external object or to an embedded object that can be displayed on a stand alone basis the dynamic user interface creates a first user interface element in the list display template and/or on the first column for facilitating the user to be able to request the visualisation of the selected attribute.

In another embodiment of the invention if the attribute is an email or an instant message address or any kind of communication medium the dynamic user interface creates a second user interface element in the list display template and/or on the first column for the user to be able to request to send a message to the recipient described by the selected attribute.

In one embodiment of the invention the dynamic user interface is operable for selecting a relationship in the table.

In another embodiment of the invention if the selected relationship is visible in the list mode the dynamic user interface creates a second column to the list display template with the appropriate column type.

In another embodiment of the invention the dynamic user interface creates a third user interface element in the list display template and/or on the second column for facilitating the user to be able to request the visualisation of the selected relationship.

In one embodiment of the invention the dynamic user interface creates a fourth user interface element in the list display template and/or on the second column for facilitating the user to be able to request to view details of a data element.

In another embodiment of the invention if the table contains an attribute of communication medium the dynamic user interface creates a fifth user interface element in the list display template operable to do a multi items/rows selection, and a first request element for facilitating the user to be able to request to send a message to the recipients identified in the selected attribute.

In one embodiment of the invention the dynamic user interface retrieves all the data elements to be displayed in the display page and displays the display page on the display means.

In another embodiment of the invention the dynamic user interface is operable in a detail mode.

In one embodiment of the invention the dynamic user interface is responsive to requests for displaying details of a specific data element from the table of the data model.

In a further embodiment of the invention the dynamic user interface creates a form page with a form display template associated to the table or with the user-preferred form template if available.

In one embodiment of the invention if the selected attribute is visible in the detail mode the dynamic user interface creates a form field on the form display template with the appropriate field type.

In another embodiment of the invention the dynamic user interface creates a sixth user interface element in the form template and/or on the form field for facilitating the user to be able to request the visualisation of the details of related attributes.

In one embodiment of the invention if the selected attribute is a file or a world wide web URL or other kind of pointer to an external object or to an embedded object that can be displayed on a stand alone basis the dynamic user interface creates a seventh user interface element for the selected attribute in the form template and/or on the form field for facilitating the user to be able to request the visualisation of the selected attribute.

In another embodiment of the invention if the selected attribute is an email or an instant message address the dynamic user interface creates an eighth user interface element in the list display template and/or on the form field for facilitating the user to be able to request to send a message to the recipient identified in the selected attribute.

In one embodiment of the invention the dynamic user interface creates a label for the form field.

In another embodiment of the invention the label is operable for facilitating the user to be able to request the visualisation of the details of related attributes.

In one embodiment of the invention if the selected attribute is a file or a world wide web URL or other kind of pointer to an external object or to an embedded object that can be displayed on a stand alone basis the label is operable for facilitating the user to be able to request the visualisation of the selected attribute.

In another embodiment of the invention if the selected attribute is an email or an instant message address the label is operable for facilitating the user to be able to request to send a message to the recipient identified in the selected attribute.

In another embodiment of the invention the dynamic user interface is operable in a query mode.

In one embodiment of the invention the dynamic user interface comprises a query list page.

In another embodiment of the invention the dynamic user interface is responsive to requests to see the query list page for a given query from the table or query menu.

In one embodiment of the invention the dynamic user interface creates the query list page with a list display template associated to the query or with the user-preferred template if available.

In another embodiment of the invention if the selected table of the query is visible in query mode the dynamic user interface creates a ninth user interface element in the list display template and/or on the column for facilitating the user to be able to do a drill down to detail view on the current attribute from the selected table.

In one embodiment of the invention if the selected attribute is visible in list mode the dynamic user interface adds a third column to the list display template with the appropriate column type using the display type from the template associated with the column type.

In another embodiment of the invention if the selected attribute is a relationship the dynamic user interface creates a tenth user interface element in the form template and/or on the form field for facilitating the user to be able to request the visualisation of the details of related attributes.

In one embodiment of the invention if the selected attribute is a file or a world wide web URL or other kind of pointer to an external object or to an embedded object that can be displayed on a stand alone basis the dynamic user interface creates an eleventh user interface element in the list display template and/or on the third column for facilitating the user to be able to request the visualisation of the file/object for the current attribute.

In another embodiment of the invention if the selected attribute is an email, an instant message address or other kind of communication medium the dynamic user interface creates a twelfth user interface element in the list display template and/or on the column for facilitating the user to be able to request to send a message to the recipient identified in the selected attribute.

In one embodiment of the invention if the selected attribute is a communication medium the dynamic user interface creates a thirteen user interface element in the list display template operable to do a multi items/rows selection, and a query request means for facilitating the user to be able to request to send a message to the recipients identified in the selected attribute.

In another embodiment of the invention the dynamic user interface retrieves all the data elements to be displayed in the query list page and displays the query list page on the display means.

In one embodiment of the invention the dynamic user interface comprises a report page.

In another embodiment of the invention the dynamic user interface creates the report page with a report display template associated to the report or with the user-preferred report template if available in response to a request to view a report.

In one embodiment of the invention the hierarchy main menu comprises a hierarchy report menu.

In one embodiment of the invention the dynamic user interface is operable to select a root section of the hierarchy report menu.

In a further embodiment of the invention the dynamic user interface is operable to select a data element of the root selection.

In one embodiment of the invention if the root section contains a data element the dynamic user interface retrieves the data element based on its definition and creates a fourteenth user interface element to access the detail view of the root section.

In one embodiment of the invention if the root section comprises a sub-section the dynamic user interface is operable to select the sub-section and operate in the same manner as it did for the root section.

In another embodiment of the invention the dynamic user interface operates in a recursive fashion for selecting the root section and any sub-sections if they exist.

In one embodiment of the invention the dynamic user interface displays the report page for each root section and sub-section.

In another embodiment of the invention the dynamic user interface creates a table page in response to a request to create a table, the table page comprises definition fields for specifying the table page definition for the design level of the user.

In one embodiment of the invention the data model of the table is defined by entering values in the definition fields on the table page.

In another embodiment of the invention the dynamic user interface is responsive to the values entered in the definition fields for generating a physical representation of the table.

In one embodiment of the invention the table definitions are saved as meta data, and the table is added to the appropriate menu to let the user access the table.

In a further embodiment of the invention attributes and relationships may be added to the table.

In one embodiment of the invention the attributes comprises a definition which is saved as meta data.

In another embodiment of the invention the dynamic user interface adds a column to the related table according to the attribute definition.

In one embodiment of the invention the relationship properties which is added to the table is defined as meta data.

In one embodiment of the invention the dynamic user interface generates a physical link to a target table as defined in the relationship properties.

In a further embodiment of the invention the dynamic user interface generates a physical link in the form of a foreign key to the target table.

In one embodiment of the invention the dynamic user interface creates a new query by creating a new data element in the query list page.

In another embodiment of the invention the dynamic user interface adds a query table in the query definition and creates a query table column for each attribute and relationship of the table.

In one embodiment of the invention the dynamic user interface displays the tables accessible from the selected table relationships and tables that have a relationship targeting the selected table.

In another embodiment of the invention the dynamic user interface adds a query table in a query definition and creates a query table column for each attribute and relationships of the table, each query column points to the definition of the table's attribute or relationship meta data.

In a further embodiment of the invention the dynamic user interface adds the table to a query hierarchy table, and displays the tables accessible through the query hierarchy table.

In one embodiment of the invention the dynamic user interface creates a new report by generating a new data element in the report list.

In another embodiment of the invention the dynamic user interface displays the list of all queries that the user has access to, the dynamic user interface is operable for selecting a query to be used in a new report section.

In a further embodiment of the invention the dynamic user interface creates the new report section in the report meta table.

In one embodiment of the invention the user can also add a filter to the query.

In another embodiment of the invention the dynamic user interface is operable for selecting a newly created report section in the hierarchy report menu.

In another embodiment of the invention the dynamic user interface is operable for adding a sub-section to the selected report section or to the hierarchy report menu.

In one embodiment of the invention the dynamic user interface displays the list of all queries that relate directly or indirectly to a parent section or sub-section that the user has access to.

In another embodiment of the invention the dynamic user interface relates the query to another query as defined by at least one existing common primary key contained in the queries.

In a further embodiment of the invention the dynamic user interface relates the query to another query by matching primary keys and/or foreign keys from one query to the other.

In one embodiment of the invention the dynamic user interface relates the query to another query by foreign keys that point to the primary key or foreign keys in the other query.

In a further embodiment of the invention two queries are related if a relationship or a primary key in any of the two queries can be matched with the primary key or a relationship in the other query.

In one embodiment of the invention the dynamic user interface is operable to select the query and the relationship for matching the query to the relationship.

In another embodiment of the invention the dynamic user interface is operable for creating a display element to the selected report section.

In one embodiment of the invention the dynamic user interface is operable to define the type of display element for example, free text merge, column text merge, free grid, list grid, chart, and heading.

In a further embodiment of the invention the dynamic user interface defines the display element using the columns of the query and free text.

In one embodiment of the invention the dynamic user interface adds the report element and its definition to the report meta table.

In one embodiment of the invention the dynamic user interface is operable to create a schedule type query, this type of query is built by creating a list of query and/or tables that contains at least one column/attribute of data type date, the result of the tables and queries will be displayed in a calendar presentation by placing the result data element name on the start date.

The invention also provides a system for generating a dynamic user interface for facilitating interface with an electronic data repository, the system comprises the data repository in which a collection of data elements is stored, a storage means storing a set of rules being communicable with a computing means for instructing the computing means to operate in a predetermined manner, a means for creating a communication link between the computing means and the data repository for communicating data over the communication link, an extracting means for extracting meta data from an existing data model describing the data elements in the data repository, a processing means for processing the extracted meta data in accordance with a predefined set of rules to generate a meta model, and a generating means for generating the dynamic user interface based on the meta model.

Additionally the invention relates to a computer programme product directly loadable into the internal memory of a computer, comprising software code portions for performing the method according to the invention for facilitating interfacing with a data repository storing a collection of data elements.

The invention also relates to a computer programme product stored on a computer usable medium, comprising a computer readable programme means for causing a computer to perform the method according to the invention for facilitating interfacing with a data repository storing a collection of data elements.

The invention also relates to a computer readable medium, having a programme recorded thereon, wherein said programme is for making a computer execute the method according to the invention for facilitating interfacing with a data repository storing a collection of data elements.

The advantages of the invention are many, one particular important advantage of the invention is provided by the fact that the dynamic user interface can interface with data elements in the data repository which are not represented in the data model, thus, the dynamic user interface is flexible in that it is the user who decides what tables from the data repository to incorporate into the dynamic user interface and not an industry specific predefined generic data model. A further advantage of the invention is provided by the fact that the meta model is responsive to an authorisation code for controlling the level of access that a user has to the data elements in the data repository. Thus, sensitive information in the data repository can be kept secure from certain individuals, while other individuals may have full access to the sensitive information. Another advantage of the invention is provided by the fact that the dynamic user interface is automatically populated with data elements when generated thereby eliminating the need for the user to import the data elements from the data repository. Thus, the possibility of the dynamic user interface being populated incorrectly with corrupt data as a result of human error is eliminated. A further advantage of the invention is provided by the fact that the layout of the dynamic user interface can be modified.

The invention will be more clearly understood from the following description of a preferred embodiment thereof, which is given by way of example only, with reference to the accompanying drawings, in which:

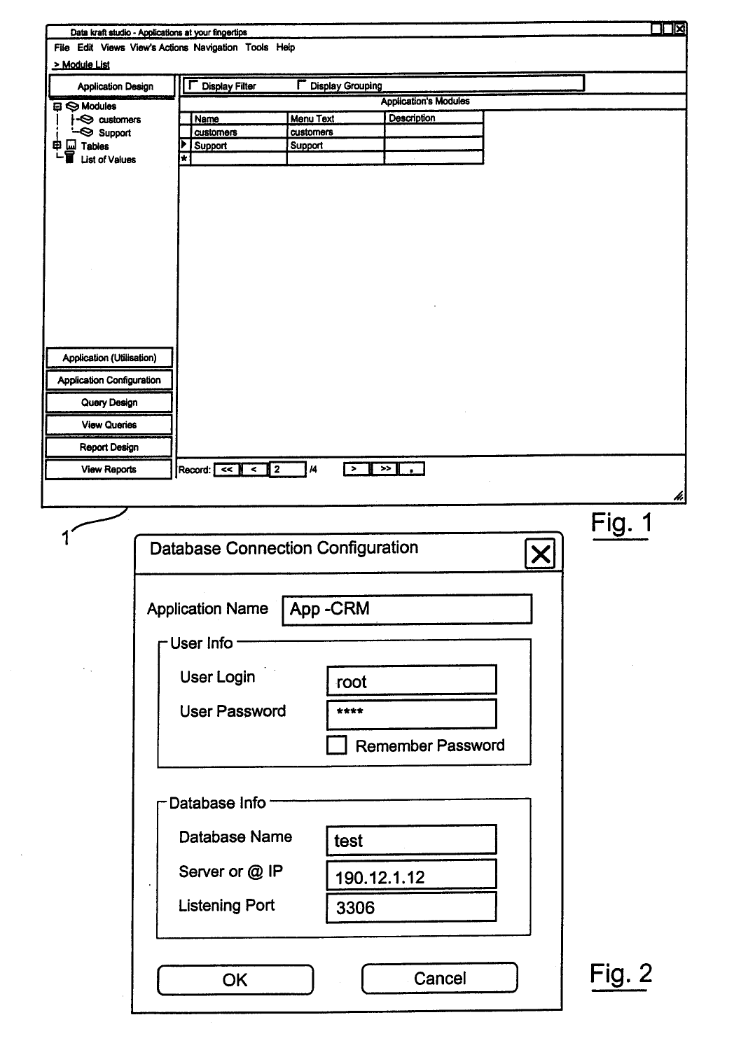

FIG. 1 is a screen shot of a dynamic user interface prepared by a method according to the invention for dynamically generating a dynamic user interface,

FIG. 2 is a screen shot of a command screen of the dynamic user interface of FIG. 1,

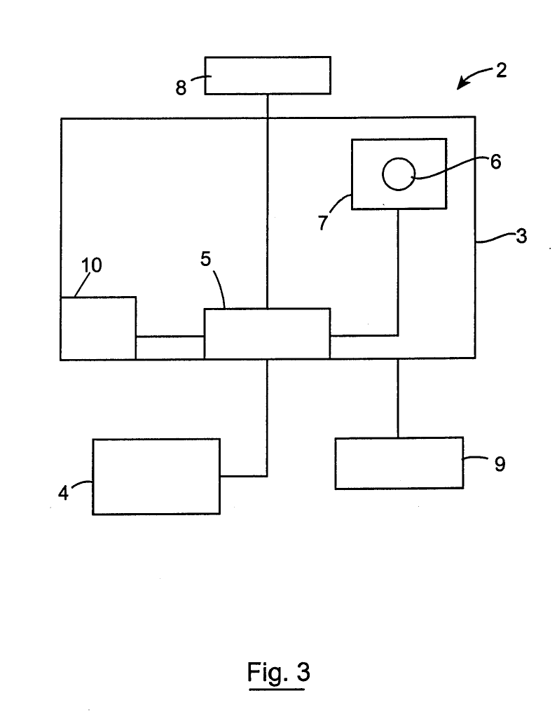

FIG. 3 is a computer system for carrying out the method according to the invention for generating a dynamic user interface,

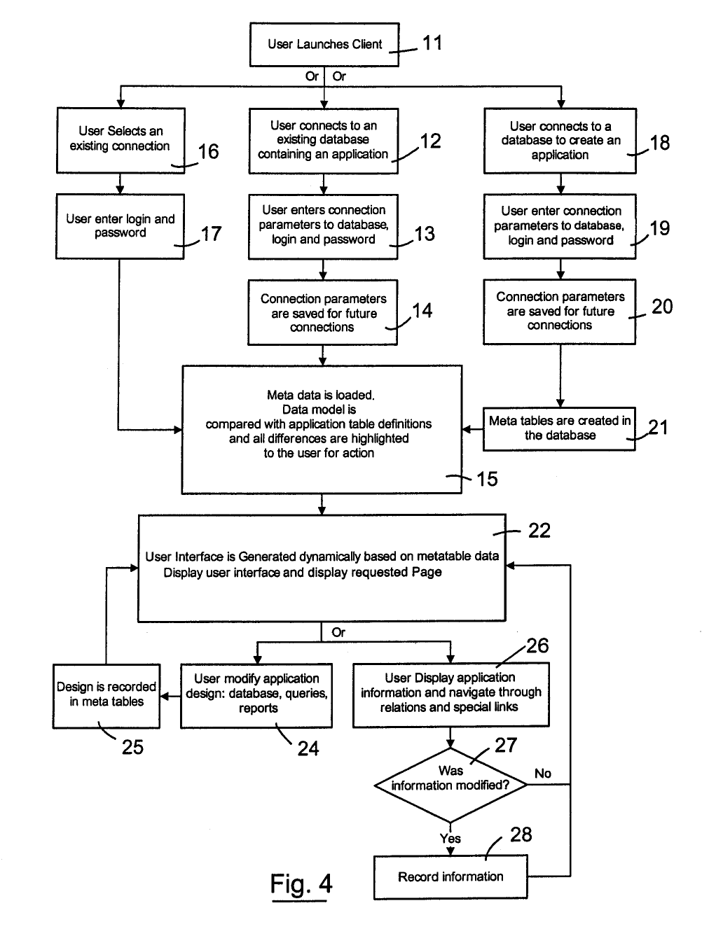

FIG. 4 is a flow chart representation of an overview of a computer programme for carrying out the method according to the invention for generating a dynamic user interface,

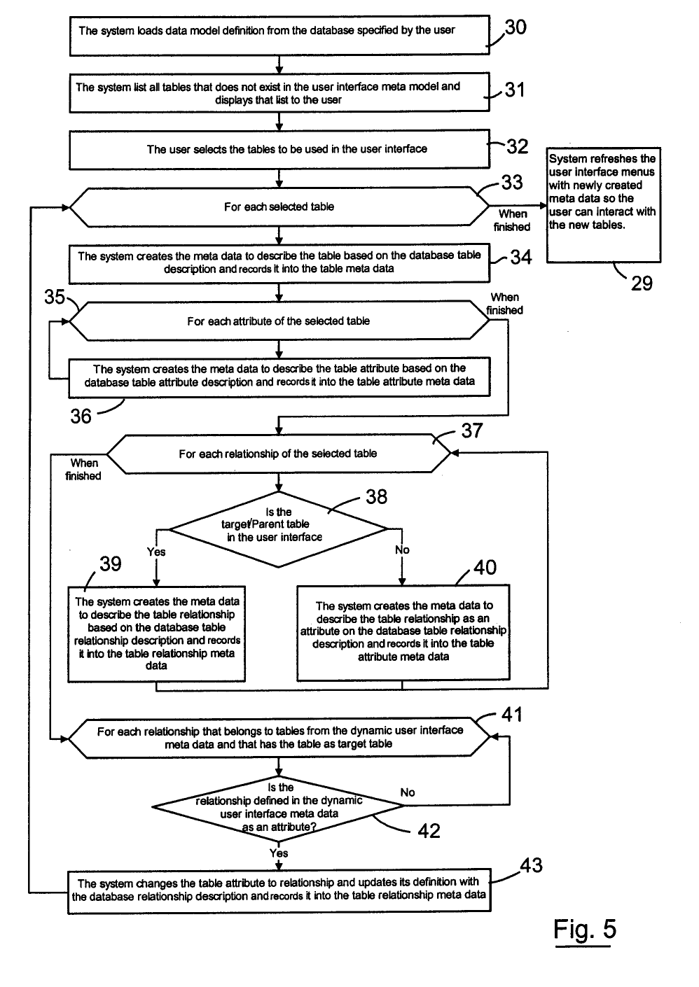

FIG. 5 is a flow chart representation of a routine of the computer programme of FIG. 4,

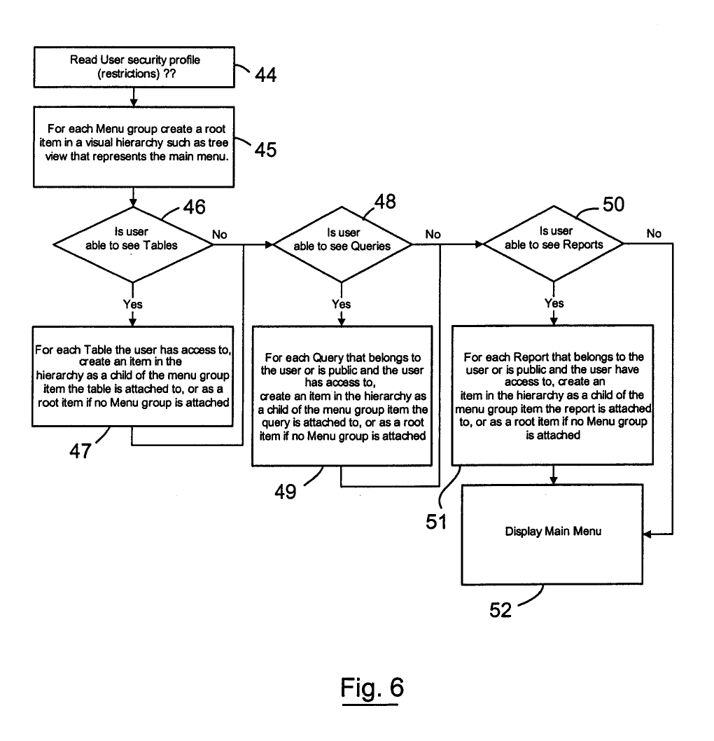

FIG. 6 is a flow chart representation of another routine of the computer programme of FIG. 4,

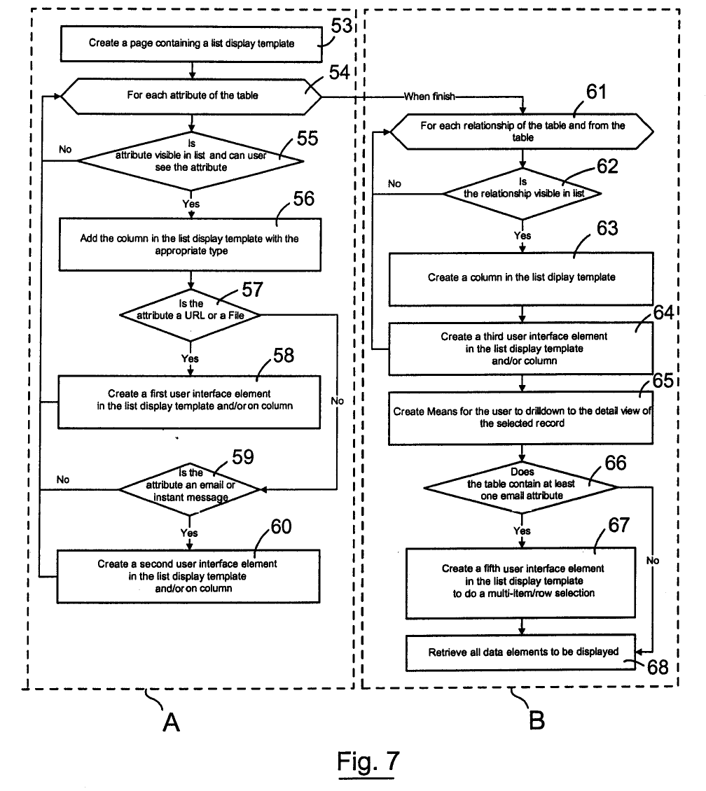

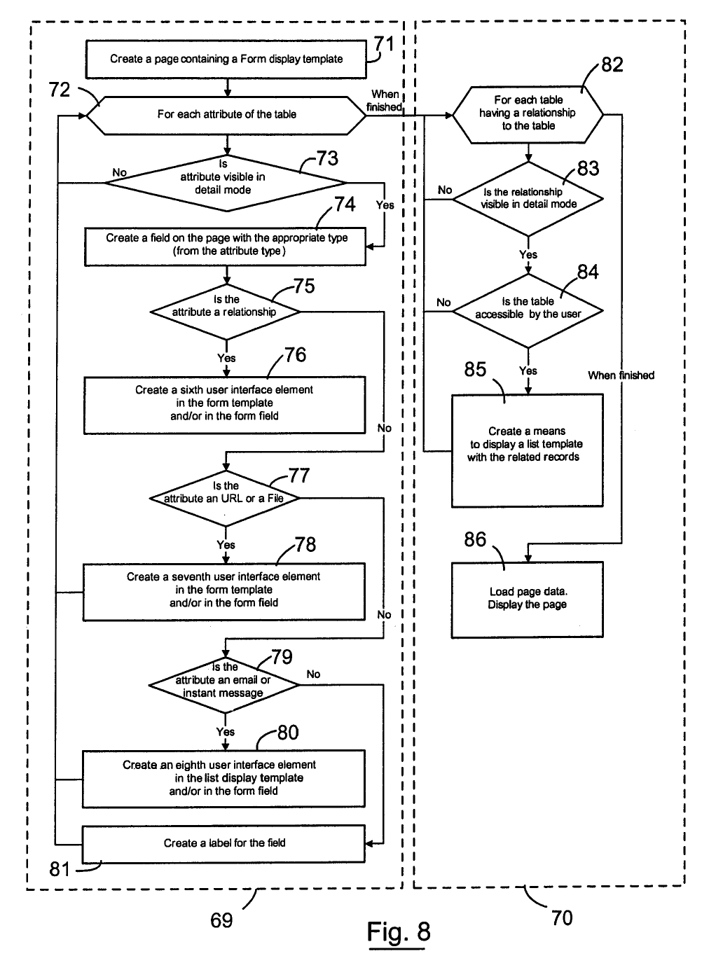

FIG. 7 is a flow chart representation of another routine of the computer programme of FIG. 4,

FIG. 8 is a flow chart representation of another routine of the computer programme of FIG. 4,

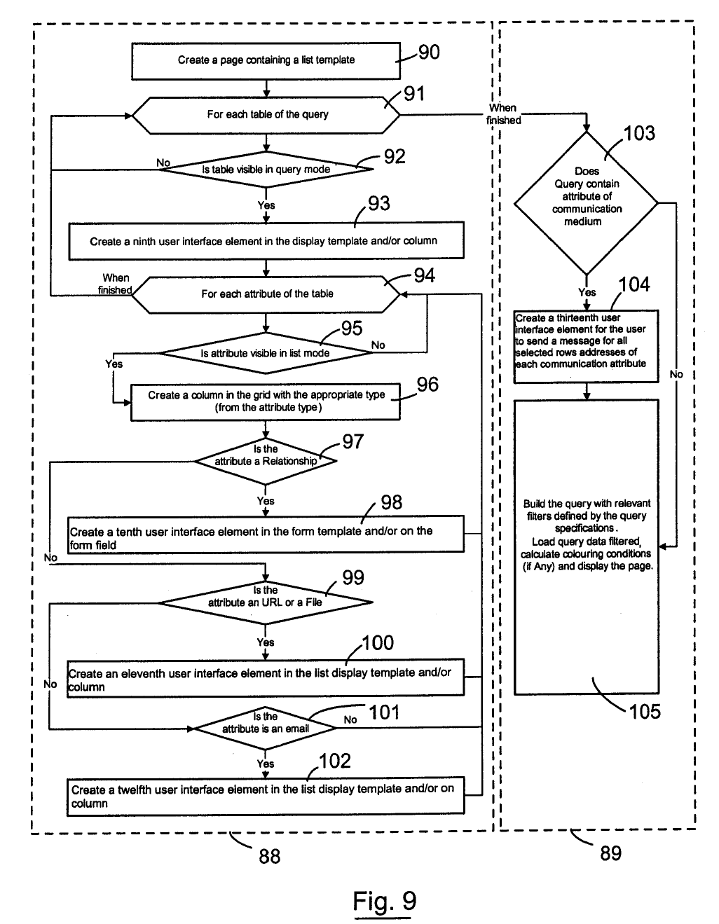

FIG. 9 is a flow chart representation of another routine of the computer programme of FIG. 4,

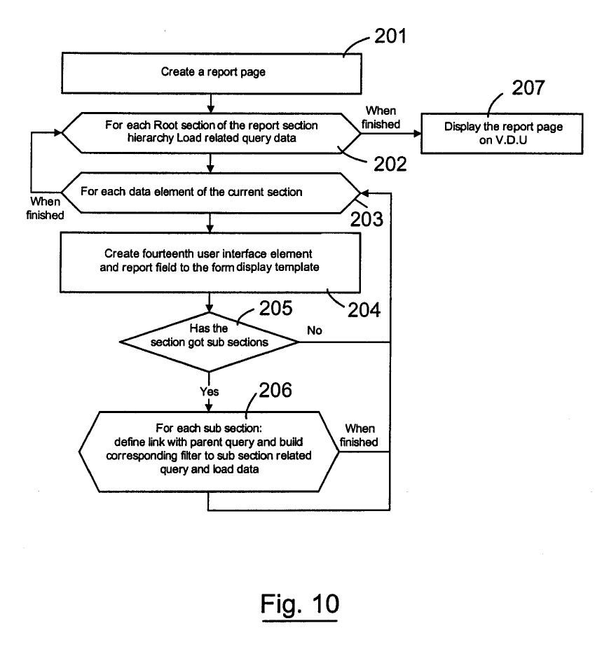

FIG. 10 is a flow chart representation of another routine of the computer programme of FIG. 4,

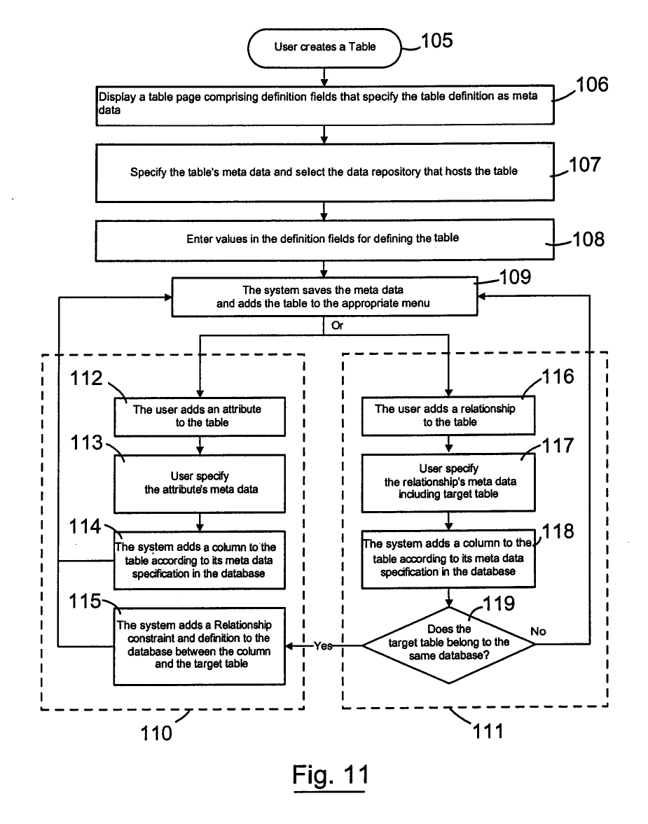

FIG. 11 is a flow chart representation of another routine of the computer programme of FIG. 4,

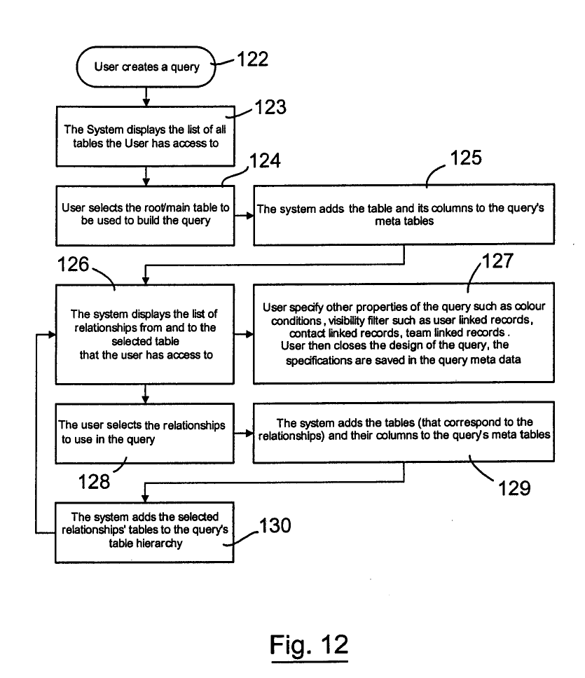

FIG. 12 is a flow chart representation of another routine of the computer programme of FIG. 4,

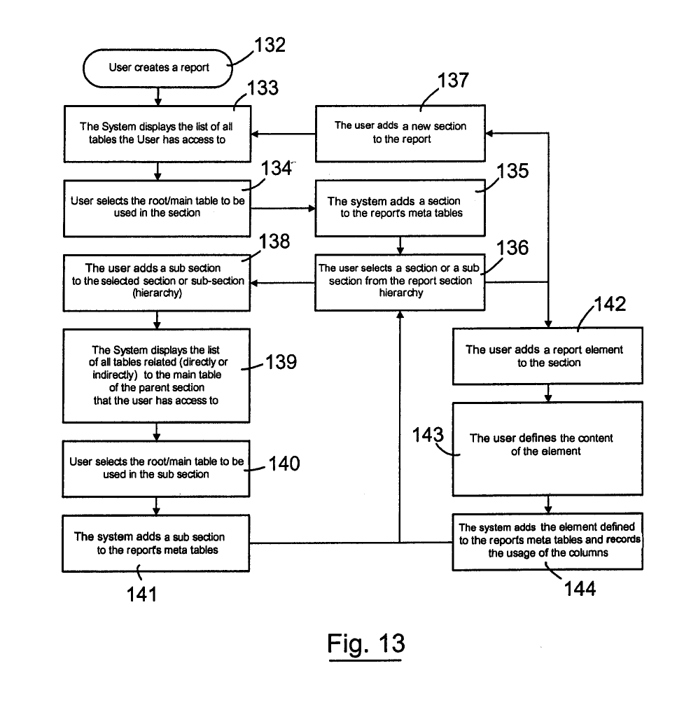

FIG. 13 is a flow chart representation of another routine of the computer programme of FIG. 4,

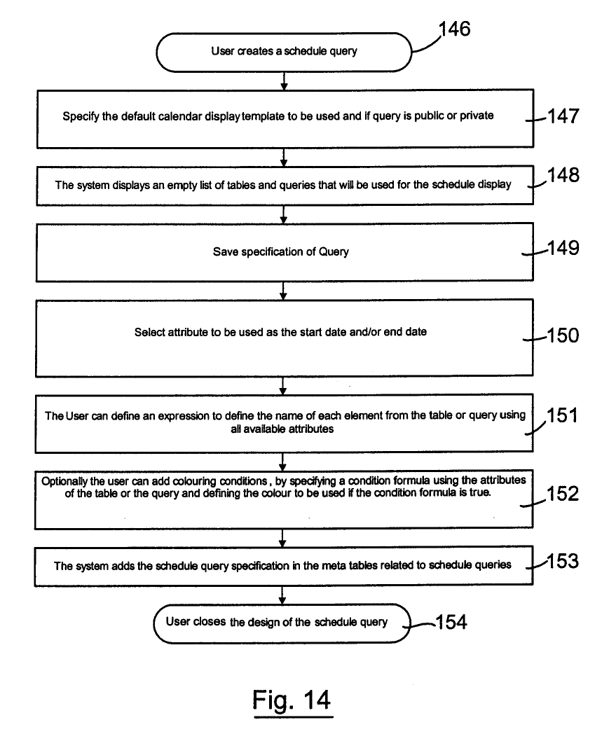

FIG. 14 is a flow chart representation of another routine of the computer programme of FIG. 4,

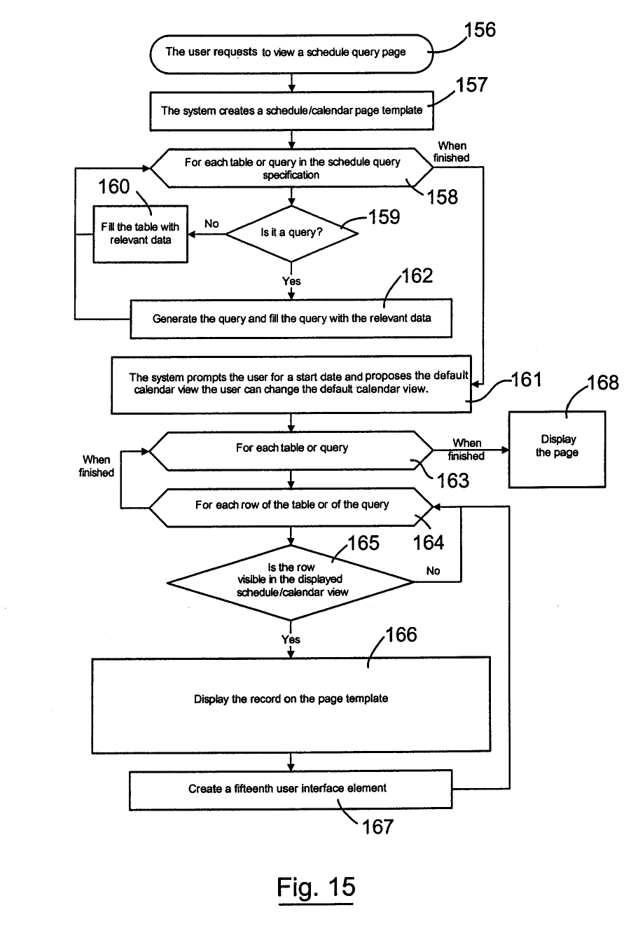

FIG. 15 is a flow chart representation of another routine of the computer programme of FIG. 4,

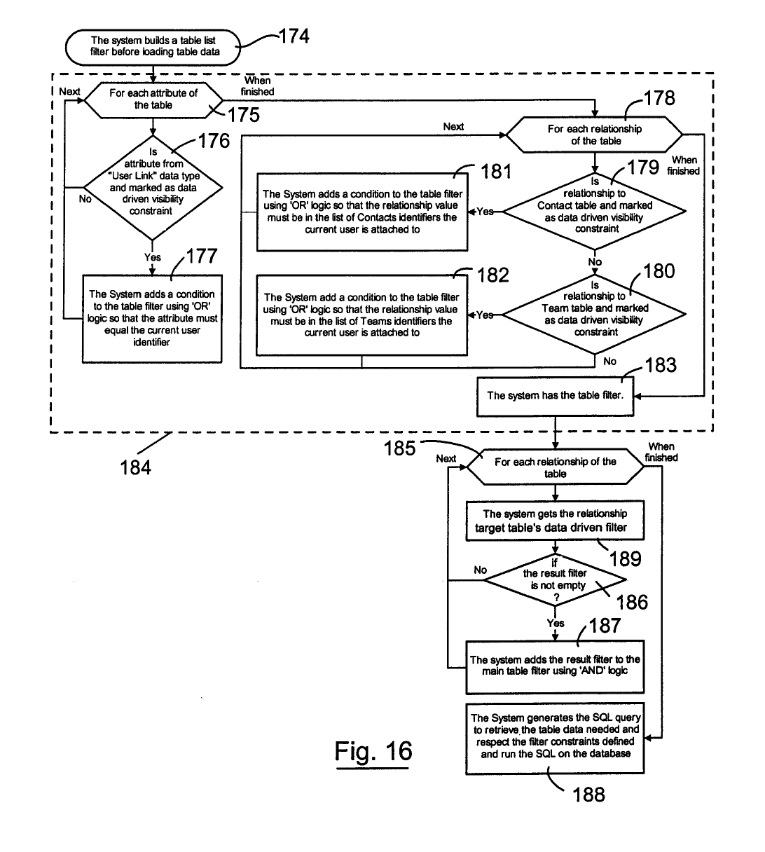

FIG. 16 is a flow chart representation of another routine of the computer programme of FIG. 4, and

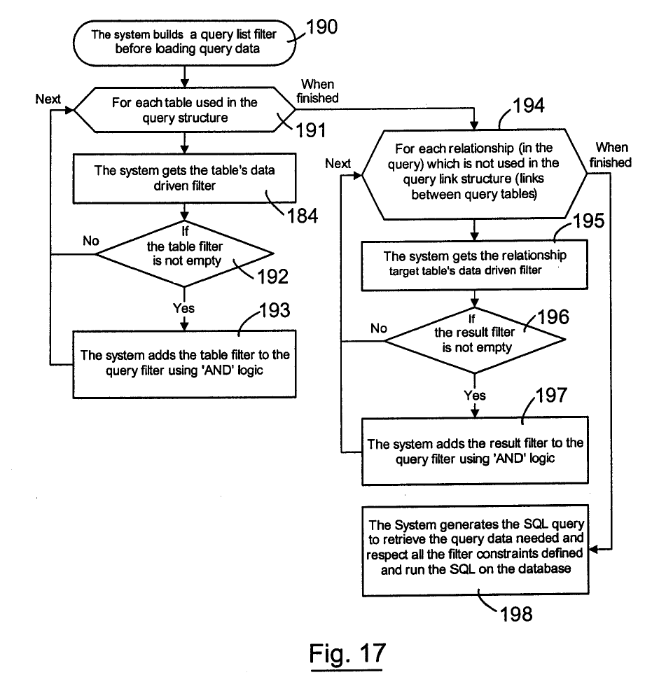

FIG. 17 is a flow chart representation of another routine of the computer programme of FIG. 4.

Referring to the drawings there is illustrated flow charts of a computer programme for carrying out a method according to the invention for generating a dynamic user interface, a representation of part of the dynamic user interface is illustrated in FIG. 1, and indicated generally by the reference numeral 1 for facilitating interfacing with an electronic data repository of a computer system 2. It will be appreciated by those skilled in the art the dynamic user interface 1 comprises a plurality of linked representations. The computer system 2 comprises a computer 3 which operates under the control of the computer programme. The data repository is stored on a remote magnetic hard disk 4 of the computer system 2 which is illustrated in FIG. 3, may be stored on the remote hard disk 4 as an XML file, MySQL, Microsoft Access, Microsoft SQL Server, Oracle database, or DB2 format. The data repository stores a collection of data elements which are stored in tabular form in a plurality of tables comprising rows and columns, as will be well known to those skilled in the art. A processing means, namely, a central processor 5 of the computer 3 is operable under a software application which is associated with the data repository for providing a data model which structures some of the data elements in the data repository in a predefined manner. The data model comprises meta data which defines a plurality of hierarchical data structures containing certain data elements for facilitating accessing, interpretation and manipulation of the data elements in the data repository in a predefined manner. The data elements at the top of each hierarchical data structure are referred to as data elements, and any data elements beneath the top data element of each hierarchical structure are referred as data attributes, syntax of this type will be well known by those skilled in the art. The only distinction between a data element and a data attribute is its position in the data hierarchy structure. Thus, data can only be presented in predetermined arrangements defined by the data model. Furthermore, only the data elements in those tables in the data repository, the main meta data descriptions of which are contained in the data model can be accessed through the data model. Such data models will be well known to those skilled in the art, as will their limitations be similarly well known to those skilled in the art.

The method according to the invention generates the dynamic user interface 1 which is derived from the existing data model in the computer 3 for facilitating access to data elements in the data repository meta data of which is not contained in the existing data model so that a user can access such additional data elements, and manipulate the data in a manner suitable and beneficial to the user. However, as will be described below the method according to the invention also includes security for controlling access to the data elements in the data repository by assigning different users security characteristics in the form of a log in name and corresponding password with different levels of access.

A computer programme for carrying out the method according to the invention for generating the dynamic user interface is stored on a computer readable storage means, in this case a CD-ROM 6, and the computer programme on the CD-ROM 6 is read by the central processor 5 through a CD-ROM drive 7. A visual display unit 8 is provided for displaying the dynamic user interface 1, one of the representations of which, namely, the representation 1 is illustrated in FIG. 1, and a keyboard 9 facilitates inputting of instructions and data by a user through the dynamic user interface 1. A local magnetic hard disk 10 is also provided on the computer 3 for providing memory which can be easily accessed by the central processor 5.

The steps which are executed by the computer programme on the CD-ROM 6 in carrying out the method for generating the dynamic user interface 1 will be now be described with reference to FIGS. 4 to 17.

FIG. 4 illustrates a flow chart representation of the computer programme for carrying out the method for generating the dynamic user interface 1. In block 11 the CD ROM 6 is placed in the CD ROM drive 7 of the computer 3 which automatically generates a command means provided by a command graphical user interface represented by the screen shot of FIG. 2 which is displayed on the visual display unit 8 of the computer 3 for facilitating the user to instruct the central processor 5 to operate in a desired manner. The command graphical user interface is responsive to requests from the user through the keyboard 9 of the computer 3 to open one of three possible communication links to the data repository. The communication link which is selected depends on whether or not it is the first time that the user has connected to the data repository, and also on whether or not a data model generated by a software application associated with the data repository exists for describing the data elements in the data repository.

The central processor 5 is instructed to open a communication link via block 12 if no previous connection has been made to the data repository stored on the remote magnetic hard disk 4 by the user and if a data model exists for the data elements in the data repository. The central processor 5 is instructed to open a communication link via block 16 if a connection already exists between the computer 3 and the data repository. The central processor 5 is instructed to open a communication link via block 18 if no previous connection exists between the computer 3 and the data repository, and if no data model exists for the data elements in the data repository.

In the event that block 12 is selected, block 13 operates as a security authorising means by performing a security profile check of the user for determining if the user is permitted to access the data repository, and if so determines the level of access that the user should be granted. Block 13 instructs the central processor 5 to request the user to enter the connection parameters to the data repository, as well as the users' security profile characteristic which the user supplies to the central processor 5 in the form of a log in name and a corresponding password. If block 13 determines that the connection parameters are correct and the entered security profile characteristic permits the user to access the data repository, a communication link between the central processor 5 and the data repository is then opened. Block 14 saves the connection parameters for the data repository for future retrieval in case the user would wish to connect the data repository at a later date. Once the connection parameters have been saved, block 15 then instructs the central processor 5 to extract the meta data description of the data elements in the data repository, in other words, the meta data defining the parameters to automatically generate the user interface generated by the software application associated with the data repository, and to store it on the local hard disk 10 of the computer 3 in the form of meta tables. A more detailed description of the operation of block 15 is described below with reference to FIG. 5, and FIG. 8.

In the event that Block 16 is selected, block 16 instructs the central processor 5 to retrieve previously saved connection parameters for re-establishing the communication link which previously existed between the computer 3 and the data repository. Once the connection parameters have been retrieved, block 17 operates as the security authorising means by instructing the central processor 5 to request the user to enter the users' security profile characteristic which the user supplies to the computer 3 in the form of a log in name and a corresponding password. If block 17 determines that the entered security profile characteristic permits the user to access the data repository, the communication link between the computer 3 and the data repository is reopened and the central processor 5 moves to block 15 which has already been described.

In the event that block 18 is selected, block 19 operates as the security authorising means by performing a security profile check of the user for determining if the user is permitted to access the data repository, and if so determines the level of access that the user should be granted. Block 19 instructs the central processor 5 to request the user to enter the connection parameters for the data repository, as well as the users' security profile characteristic which the user supplies to the computer 3 in the form of a log in name and a corresponding password. If block 19 determines that the connection parameters are correct and the entered security profile characteristic permits the user to access the data repository, a communication link between the computer 3 and the data repository is opened. Block 20 instructs the central processor 5 to save the connection parameters for the data repository for future retrieval in case the user should wish to connect the data repository at a later date. Once the connection parameters have been saved, block 21 then instructs the central processor 5 to create meta tables for the data elements in the data repository, in this case, there is no software application associated with the data repository for defining the data model, creating meta tables is well known to those skilled in the art and it is not intended to describe it further. When the meta tables have been created the central processor 5 moves to block 15 which has already been described.

Returning now to block 15, once the meta data of the data model has been successfully loaded on the local hard disk 10 of the computer 3 from the remote hard disk 4 under the control of block 15, the central processor 5 moves to block 22. Block 22 instructs the central processor 5 to interpret the security profile characteristic of the user and to analysis the meta data in accordance with the set of rules installed on the computer 3 from the CD ROM 6 for generating the dynamic user interface 1 based on the analysis of the meta data of the meta model. A more detailed description of the operation of block 22 is described below with reference to FIG. 7.

Block 22 instructs the central processor 5 to process the meta model for enabling the central processor 5 to generate the dynamic user interface I in the form of a graphical user interface display on the visual display unit 8 containing a plurality of pages populated with data elements from the data repository which permits the user to interface directly with the data repository, it will be appreciated by those skilled in the art that each page is in the form of a graphical user interface display linked to the representation 1 of FIG. 1. Thus, depending on the security characteristic of the user, different users may have different graphical user interface displays with varying degrees of access to the data repository. In one embodiment of the invention for example, a manager could be assigned a security profile characteristic that permits the manager to have full access to all the data elements in the data repository through the graphical user interface display, while a sales person could be assigned a security profile characteristic that permits the sales person to have limited access to data elements in the data repository relating to sales.

On completion of the processing of the meta model to generate the dynamic user interface 1, and on completion of the dynamic user interface 1 the central processor 5 moves to either one of block 24 or block 26. The central processor 5 moves to block 24 when the user wishes to modify the layout of the dynamic user interface 1, and central processor 5 moves to block 26 if the user is satisfied with the layout of the dynamic user interface 1. Block 24 is responsive to instructions from the user through the keyboard 8 for instructing the central processor 5 to modify the meta data of the meta model in a predefined manner to alter the layout the graphical user interface display. A more detailed description of the operation of block 24 is described below with reference to FIG. 11, FIG. 12, FIG. 13 and FIG. 14. Once the meta data has been modified, the central processor 5 moves to block 25 which records the modification of the meta data in the meta tables. The central processor 5 then moves to block 22 which operates as previously described.

However, if the user is satisfied with the design of the graphical user interface display, the central processor 5 moves to block 26 which allows the user to navigate through the pages of the graphical user interface display for interfacing directly with the data repository. A more detailed description of the operation of block 26 is described below with reference to FIG. 7, FIG. 8, FIG. 9, FIG. 10 and FIG. 15. Once block 26 has completed its tasks, the central processor 5 moves to block 27 to determine if any of the data elements or their associated attributes in the data repository are modified when the user is navigating through the pages of the dynamic user interface 1. If block 27 determines that the data elements or their associated attributes have been modified, the central processor 5 then moves to block 28 which records the modifications to the data elements and instructs block 22 to update the graphical user interface display to display the modified data. If block 27 determines that no modifications were made, block 27 informs block 22 that no modifications were made and that the current graphical user interface display is up to date.

Referring now to FIG. 5, there is illustrated a flow chart representation of a sub-routine for creating and setting the meta data of tables which exist in the data repository but are not contained in the existing data model, the sub-routine is executed by block 15 of the computer programme of FIG. 4.

Block 30 requests the data repository selected by the user using to list all tables that exist in the data repository but do not exist in the meta data of the meta model initially used by the computer 3 to generate the dynamic user interface 1. The central processor 5 under the control of block 30 compares an inherent data repository description of each table in the data repository to the meta data description of the existing data model for generating the list of tables. When the central processor 5 has the list of tables complete, the central processor 5 moves to block 31 which instructs the central processor 5 to display the list of tables on the visual display unit 8 of the computer 3. The central processor 5 moves to block 32 in response to the user selecting tables from the list using the keyboard 9 or some other suitable data input device for informing the central processor 5 which tables the user selects from the list of tables. Then block 33 sets up a recursive process which instructs the central processor 5 to step through each selected table. For each step in the recursive process of block 33, block 34 instructs the central processor 5 to create a meta data description of the selected table of the current table iteration from block 33 based on the data repository description of the selected table stored on the remote magnetic hard disk 4. The generated meta data description is then entered into the appropriate generated meta table on the local -hard disk 10 of the computer 3, and is used for updating the meta model from which the dynamic user interface 1 is then re-generated together with the other meta data of the data model imported from the software application associated with the data repository. Block 35 then sets up a recursive process within the recursive process of block 33 which steps through each attribute of the selected table. For each step in the recursive process of block 35, block 36 creates a meta data description for each attribute based on the data repository description of the attribute stored in the remote magnetic hard disk 4, and enters this meta data into the appropriate attribute meta data table on the local hard disk 10 of the computer 3. The generated meta data is used for updating the meta model.

Once block 35 has stepped through each attribute in the selected table, block 35 sets up a recursive process within the recursive process of block 33 which steps through each relationship of the selected table of the current table iteration from block 33. For each step in the recursive process of block 37, block 38 determines if the relationship links the selected table to another table which can be considered to be a target/parent table and if the target/parent table exists in the meta data of the initial meta model. If block 38 determines that the target/parent table does exist in the meta data of the initial meta model, then block 39 creates a meta data description of the relationship based on the data repository table relationship description of the relationship stored in the remote magnetic hard disk 4, and enters this meta data description into the appropriate meta table relationship meta table on the local hard disk 10 of the computer 3. This meta data description is subsequently used to update the meta model. If block 38 determines that the target/parent table does not exist in the meta data of the initial meta model of the dynamic user interface 1, block 40 creates a meta data description of the relationship as an attribute based on the data repository table relationship description of the relationship stored in the remote magnetic hard disk 4 and enters this meta data description into the appropriate attribute meta table on the local hard disk 10 of the computer 3. This meta data description is used to update the meta model.

Once the recursive process of block 37 has been completed the central processor 5 moves to block 41 which initiates another recursive process within the recursive process of block 33 for each relationship of the tables which are defined in the dynamic user interface 1 meta data repository that point to the current table of the recursive process defined in block 33. For each step of the recursive process of block 41, block 42 determines whether the relationship is defined in the meta data of the initial meta model as an attribute. If block 42 determines that the relationship is defined in the meta data of the initial meta model as an attribute, block 43 alters the attribute to be a relationship and updates its definition in the meta data repository on the remote magnetic hard disk 4 using the relationship description from the data repository, and records the relationship into the relationship meta data table on the local hard disk 10 of the computer 3. If block 42 determines that the relationship is not defined as an attribute in the meta data of the initial meta model, it instructs the central processor 5 to return to block 41 which steps to the next relationship. Once the recursive process of block 41 has been completed the central processor 5 moves to the next table in the recursive process of block 41. When the recursive process of block 41 is complete, the central processor 5 moves to block 29 which updates the dynamic user interface 1 by refreshing it to be indicative of the updated meta model. Once the dynamic user interface 1 is refreshed, the user is able to interface with tables that were not accessible through the software application associated with the data repository, together with the tables that were accessible through the software application associated with the data repository.

Referring now to FIG. 6, there is illustrated a flow chart representation of a sub-routine executed by block 22 of the computer programme of FIG. 4 for creating menus. Block 44 reads the user's security profile characteristics in other words, the user's password and login name. The central processor 5 then moves to block 45, for each menu group associated to the user in the meta model create a root item in a tree structure which represents the main menu of the dynamic user interface 1. The central processor 5 then moves to block 46 which determines is the user able to see tables. If block 46 determines that the user is able to see tables then the central processor 5 moves to block 47. For each table that the user has access to, block 47 creates an item in the tree structure as a child of the menu group item that the table is attached to, or as a root item if no menu group is attached. Once block 47 has completed its task the central processor moves to block 48, which is described below. However, if block 46 determines that the user is not able to see tables, the central processor 5 moves to block 48 which determines if the user is able to see queries. If block 48 determines that the user is able to see queries, the central processor 5 moves to block 49. For each query that belongs to the user or is public and that the user has access to, block 49 creates an item in the tree structure as a child of the menu group item that the query is attached to, or as a root item if no menu group is attached. Once block 49 has completed its task, the central processor 5 moves to block 50. Returning now to block 48, if block 48 determines that the user is unable to see queries, the central processor 5 moves to block 50 which determines if the user is able to see reports. If block 50 determines that the user is able to see reports, the central processor 5 moves to block 51. For each report that belongs to the user or is public and that the user has access to, block 51 creates an item in the tree structure as a child of the menu group item that the report is attached to, or as a root item if no menu group is attached. Once block 51 has completed its task, the central processor 5 moves to block 52 which instructs the central processor 5 to display the graphical user interface display with the main menu completed.

Returning now to block 50, if block 50 determines that the user is unable to see reports, the central processor 5 moves to block 52 which operates as previously described.

Referring now to the flow chart of FIG. 7, there is illustrated a flow chart representation of a sub-routine for compiling the contents of a table, the sub-routine is executed by block 26 of the computer programme of FIG. 4. The flow chart is divided into two main sections, namely, section A and section B. The operation of section A will first be described. When the user requests to see a list display page for a given table from the table hierarchical menu, block 53 instructs the central processor 5 to create a list display page with a list display template associated to the table.

Block 54 then instructs the central processor 5 to select an attribute from the table. Block 55 then determines if the selected attribute is visible in a list mode. If the selected attribute is not visible in the list mode, the central processor 5 returns to block 54 which instructs the central processor 5 to select the next attribute. This process will continue in a sequential fashion. If block 55 determines that the selected attribute is visible in the list mode and can be seen by the user, then block 56 instructs the central processor 5 to add a column to the list display template with the appropriate column type. Then block 57 determines if the selected attribute is a file or a world wide web URL or a pointer to an external object or to an embedded object that can be displayed on a stand alone basis. If block 57 determines that the selected attribute can be displayed on a stand alone basis, the central processor 5 moves to block 59 which is described below. If block 57 determines that the selected attribute cannot be displayed on a stand alone basis, then block 58 creates a first user interface element in the list display template and/or on the column on the graphical user interface display for facilitating the user to be able to request the visualisation of the selected attribute. Once the first user interface element has been created, the central processor 5 moves to block 54, which operates as previously described. Returning now to block 59 which determines if the selected attribute is an email or an instant message address or any kind of communication medium. If block 59 determines that the attribute is not a communication medium, the central processor 5 returns to block 54 which operates as previously described. If block 59 determines that the attribute is a communication medium, the central processor 5 then moves to block 60 which creates a second user interface element in the list display template and/or on the column of the graphical user interface display for facilitating the user to be able to request to send a message to the recipient identity described by the selected attribute. Once block 60 has created the second user interface element the central processor 5 returns to block 54 which operates as previously described. Once the operation of section A is complete, the central processor 5 moves to block 61 of section B. Block 61 selects a relationship in the table. Then block 62 determines if the selected relationship is visible in the list mode. If block 62 determines that the selected relationship is not visible in the list mode, the central processor 5 returns to block 61 which selects the next relationship in the table. If block 62 determines that the selected relationship is visible in the list mode, then the central processor 5 moves to block 63 which creates a column to the list display template with the appropriate column type. Once block 63 has created the column, block 64 creates a third user interface element in the list display template and/or on the column on the graphical user interface display for facilitating the user to be able to request the visualisation of the selected relationship. Then block 65 creates a fourth user interface element in the list display template and/or on the column for the user to be able to request to view the current data elements details such as hyperlink and/or contextual menu that represents the data element. Then block 66 determines if the table contains an attribute of communication medium. If block 66 determines that the table does contain an attribute of communication medium, the central processor 5 moves to block 68 which is described below. If block 66 determines that the table contains an attribute of communication medium, then block 67 creates a fifth user interface element in the list display template operable to do a multi items/rows selection, and a first request element for the user to be able to request to send a message to the recipients identified in the selected attribute. The central processor 5 then moves to block 68 which retrieves all data elements to be displayed in the display page and displays the display page on the visual display unit 8.

Referring now to the flow chart of FIG. 8, there is illustrated a flow chart representation of a sub-routine for compiling the contents of a table, the sub-routine is executed by block 26 of the computer programme of FIG. 4. The flow chart is divided into two main sections, namely, section 69 and section 70. The operation of section 69 will first be described. When the user requests to see the details of a specific data element from a table of block 15 of the flow chart of FIG. 4, block 71 creates a form page with a form display template associated to the table. Block 72 selects an attribute of the table. Then block 73 determines if the attribute selected by block 72 is visible in a detail mode. If block 73 determines that the selected attribute is not visible in detail mode, the central processor 5 returns to block 72, which selects the next attribute in the table. If block 73 determines that the selected attribute is visible in the detail mode, block 74 then creates a form field on the form display template with the appropriate field type. Once block 74 has created the form field, block 75 determines if the selected attribute is a relationship. If block 75 determines that the selected attribute is a relationship, the processor moves to block 76 which creates a sixth user interface element in the form template and/or on the form field for facilitating the user to be able to request the visualisation of details of related data elements. Once the operation of block 76 is complete the central processor 5 moves to block 72 which operates as previously described. However, if block 75 determines that the selected attribute is not a relationship the processor moves to block 77 which determines if the selected attribute is a file or a world wide web URL or other kind of pointer to an external object or to an embedded object that can be displayed on a stand alone basis. If block 77 determines that the selected attribute can be displayed on a stand alone basis, the central processor 5 moves to block 78 which instructs the central processor 5 to create a seventh user interface element in the form template and/or on the form field for facilitating the user to be able to request the visualisation of details of related data elements. Once the seventh user interface element means has been created, the central processor 5 moves to block 72 which operates as previously described. However, if block 77 determines that the selected attribute cannot be displayed on a stand alone basis, the central processor 5 moves to block 79 which determines if the selected attribute is an email or an instant message address. If block 79 determines that the selected attribute is an email or an instant message address, the central processor 5 moves to block 80 which creates an eighth user interface element in the list display template and/or on the form field for the user to be able to request to send a message to the recipient identified in the selected attribute. Once the operation of block 80 is complete, the central processor 5 moves to block 72 which operates as previously described. However, if block 79 determines that the selected attribute is not an email or an instant message address, the central processor 5 moves to block 81 which creates a label for the form field, then the central processor 5 moves to block 72 which operates as previously described. Once the operation of block 69 is complete the central processor 5 moves to block 82 of section 70 which sets up a recursive process. For each step in the process of block 82, block 83 selects a table and determines if it has a relationship to another table. If block 83 determines that the selected table does not have a relationship to another table, then the central processor 5 moves to block 86 which displays the form page. If block 83 determines that the selected table has a relationship to another table, then block 84 determines if the relationship is visible in detail mode. If block 84 determines that the relationship is not visible in the detail mode, the central processor 5 moves to block 82 which selects the next table and operates as previously described. If block 83 determines that the relationship is visible in the detail mode, then block 84 determines if the selected table is accessible by the user. If block 84 determines that the selected table is not accessible by the user, the central processor 5 moves to block 82 which selects the next table, and operates as previously described. If block 84 determines that the table is accessible by the user, then block 85 adds the list display template associated to the table having the relationship to display data elements related to the master data element displayed in the form template. It will be appreciated by those skilled in the art that other special graphical user interface elements could be used to minimise the length of the form page such as tab control or any other similar features to display multiple elements in the same display zone. Once block 85 has completed its operation, the central processor 5 moves to block 82 which selects the next table and operates as previously described.

Referring now to the flow chart of FIG. 9, there is illustrated a flow chart representation of a sub-routine for compiling the contents of a query list page, the sub-routine is executed by block 26 of the computer programme of FIG. 4. The flow chart is divided into two main sections namely, section 88 and section 89. The operation of section 88 will be described first. When the user requests to see a list page for a given query from the table or query menu. Block 90 creates a query list page with the list display template associated to the query. Then block 91 selects a table of the query. Block 92 then determines if the selected table is visible in a query mode. If block 92 determines that the selected table is not visible in query mode, the central processor 5 returns to block 91 which selects the next table of the query. If block 92 determines that the table is visible in query mode, block 93 then creates a ninth user interface element in the list display template and/or on the column for facilitating the user to be able to do a drill down to detail view on the current data element from this table such as hyperlink and/or contextual menu. Block 94 then selects an attribute of the table, then block 95 determines if the selected attribute is visible in list mode. If block 95 determines that the attribute is not visible in list mode, the central processor 5 returns to block 94 which selects the next attribute of the table. If block 95 determines that the selected attribute is visible in list mode, block 96 adds a column to the list display template with the appropriate column type using the display type from the template associated with the column type. Once block 96 has successfully added the column, block 97 then determines if the selected attribute is a relationship. If block 97 determines that the selected attribute is a relationship, the central processor 5 moves to block 98 which creates a tenth user interface element in the form template and/or on the form field for the user to be able to request the visualisation of the details of related data elements. Once block 98 has successfully completed its operation, the central processor 5 returns to block 94 which selects the next attribute in the table.

However, if block 97 determines that the selected attribute is a not relationship, the central processor 5 moves to block 99 which determines if the selected attribute is a file or a world wide web URL or other kind of pointer to an external object or to an embedded object that can be displayed on a stand alone basis. If block 99 determines that the selected attribute can be displayed on a stand alone basis, the central processor 5 moves to block 100 which creates an eleventh user interface element in the list display template and/or on the column for the user to be able to request the visualisation of the file/object for the current data element. Once the operation of block 100 is complete the central processor 5 moves to block 94 which operates as previously described. However, if block 99 determines that the selected attribute cannot be displayed on a stand alone basis, the central processor 5 moves to block 101 which determines if the selected attribute is an email, an instant message address or other kind of communication medium. If block 101 determines that the selected attribute is a communication medium, the central processor 5 moves to block 102 which creates a twelfth user interface element in the list display template and/or on the column for facilitating the user to be able to request to send a message to the recipient identified in the selected attribute. When block 102 has successfully completed its operation, the central processor 5 moves to block 94 which operates as previously described. However if block 101 determines that the selected attribute is not a communication medium, the central processor 5 moves to block 94 which operates as previously described. Once the operation of section 88 is complete, the central processor 5 moves to block 103 of section 89.

Block 103 determines if the query contains an attribute of communication medium. If block 103 determines that the query does contain an attribute of communication medium, the central processor 5 moves to block 104 which creates a thirteenth user interface element in the list template operable to do a multi items/rows selection and a query request means for facilitating the user to be able to request to send a message to the recipients identified in this attribute for the selected data elements such as hyperlink and/or contextual menu. Once the operation of block 104 has been complete, the central processor 5 moves to block 105 which instructs the central processor 5 to build the query with relevant filters defined by a query specification which allows the user to see data elements which are linked to the user's security profile characteristic, data elements that are linked to a contact associated with the user's security profile characteristic, or data elements that are linked to teams of contacts associated with the user's security profile characteristic. Block 105 instructs the central processor 5 to load the query data filter, calculate colouring conditions if specified in the query data filter and display the query list page populated with the relevant data elements for displaying on the visual display unit 8. However, if block 103 determines that the query does not contain an attribute of communication medium, the central processor 5 moves to block 105 which operates as previously described.

Referring now to the flow chart of FIG. 10, there is illustrated a flow chart representation of a sub-routine for compiling the contents of a report, the sub-routine is executed by block 26 of the computer programme of FIG. 4. When the user requests to see a report from the main menu or from the report menu. Block 201 instructs the central processor 5 to create a report page with the report display template associated to the report Block 202 selects a root section of the report section hierarchy and loads related query data to the central processor 5. Then block 203 selects a data element of the root selection. If block 203 determines that there is no data element in the root selection, the central processor 5 moves to block 202 which selects the next root section. However, if block 203 successfully selects a data element, block 204 then interprets the data element based on its definition and provides a fourteenth user interface element to access the detail view of the current section. It then adds a report field to the form display template with the appropriate field type using the display type from the template associated with the column type. Block 205 then determines if the current section comprises a sub-section. If block 205 determines that the current section has no sub-section, the central processor 5 moves to block 203, which selects the next section and operates as previously described. However, if block 205 determines that the section comprises a sub-section, for each sub-section block 206 defines a link with a parent query and builds the corresponding filter to the sub-section related query and loads the relevant data elements. The central processor 5 then moves to block 203 which operates as previously described. This is a recursive process that processes the hierarchy of sections/sub-sections accordingly. Once all the sections and sub-sections have been processed, block 207 displays a report page for each section/sub-section.

Referring now to the flow chart of FIG. 11, there is illustrated a flow chart representation of a sub-routine for creating and modifying a table, the sub-routine is executed by block 24 of the computer programme of FIG. 4. When the user requests to create a table, block 105 responds to the request and instructs the central processor 5 to create a table. Block 106 displays a table page comprising definition fields that specify the table definition for instructing the central processor 5 to generate predefined meta data. Block 106 lets the user choose the design complexity level they want to use for defining the data model. Once block 106 has completed its task, block 107 allows the user to specify the table's meta data and to select the data repository that hosts the table if multiple data repositories are available. Then block 108 defines the table by entering the values in the definition fields on the table page. Then block 108 adds physicality to the table. Then block 109 saves the table definition in the meta data and adds the table to the appropriate menu to let the user access the new table.

The user can now add attributes or relationships to the table by following the steps of either block 110 or block 111.

The operation of block 110 will now be described, block 1 12 adds an attribute to the table. Then block 113 specifies the properties of the attribute in the meta data. Once the attributes have been specified, block 114 adds a column to the related table according to the attribute's definition. Block 115 then refreshes the menu display to reflect the new tables' attribute.

The operation of block 111 will now be described, block 116 adds a relationship to the table. Then block 117 specifies the properties of the relationship in the meta data. Once the properties of the relationship have been specified, block 118 adds physically in the form of a foreign key to the related table according to the relationship definition. Block 119 then determines if the target table of the relationship is in the same data repository as the table owning the relationship. If block 119 determines that the relationship is from the same data repository, then block 119 adds a foreign key or similar constraint to the table in the data repository of block 115. If block 119 determines the data repository is not the same, the central processor 5 moves to block 109 which refreshes the menu display to reflect the new tables' attribute.

Referring now to the flow chart of FIG. 12, there is illustrated a flow chart representation of a sub-routine for creating and modifying a query, the sub-routine is executed by block 24 of the computer programme of FIG. 4. Block 122 creates a new query by creating a new data element in the query list and specifies the type of query. The following process describes the hierarchical query type. This type of query is built by creating a hierarchy of tables using the relationships between the tables and sub-tables. The sub-tables of a selected table in the hierarchy can be either tables that have a relationship to the selected table or to target tables of the selected table relationships. This hierarchy query type is translated into a SQL statement to query the data repository. If the tables belong to more than one data repository the SQL is broken down in sub-queries that target only one data repository.

Block 123 then displays the list of all the tables the user has access to. Block 124 then allows the user to select the main/root table for the query hierarchy. Then block 125 adds a query table in the query definition and creates a query table column for each attribute and relationship of the table. Block 126 then displays the tables accessible from the selected table relationships and tables that have a relationship targeting the selected table. The visual display unit 8 displays both the table and the relationships used.

The user through block 128 selects the relationships in the query. Block 129 then adds a query table in the query definition and creates a query table column for each attribute and relationship of the table. Every query column points to a definition of the tables' attribute or relationship meta data. Then block 130 adds the table to the query tables hierarchy, and displays the tables accessible through this table. The central processor 5 then returns to block 1.26, and the process continues. Block 127 allows the user to specify other properties of the query such as colour conditions, visibility filters such as user linked records, contact linked records, team linked records. When the user has finished the design of the query the user closes the query design page and block 127 saves the query specifications.

Referring now to the flow chart of FIG. 13, there is illustrated a flow chart representation of a sub-routine for creating and modifying a report, the sub-routine is executed by block 24 of the computer programme of FIG. 4. Block 132 creates a new report by creating a new data element in the report list and specifies the type of report. Then block 133 displays the list of all tables that the user has access to. The user then through block 134 selects the root/main query table to be used for the new report section. Then block 135 creates the new report section in the report meta table. The user can also add a filter to the query. The user through block 136 selects the newly created report section in the report section hierarchy menu. The user has now three choices, the user can add another report section to the report and loop back to block 133.

Alternatively, the user through block 138 can add a sub-section to the selected report section or sub-section to the report section hierarchy menu, the central processor 5 then displays the list of all queries that relate directly or indirectly to the parent section or sub-section that the user has access to. Block 139 relates the query to another query as defined by the existing common primary keys contained in the queries or identical foreign keys or foreign keys that point to a primary key in the other query. Two queries are related if a relationship or a primary key in any of the two queries can be matched with a primary or a relationship in the other query. The user through block 139 selects the query and the relationship or matches the primary keys to join the two queries. The user can specify more than one link to join the two queries. The user can also add a filter to the query. Then the user through block 140 selects the root/main query table for the new sub-section. Then block 141 adds the sub-section to the report which is also added to the section hierarchy report menu.

The users final choice is via block 142 which permits the user to add a display element to the selected report section or sub-section. Then block 143 allows the user to define the type of report element for example, free text merge, column text merge, free grid, list grid, chart, and heading. The user defines the specifications of the report element using formatted text and the columns accessible from the main table of the section/sub-section and from all the cascading parent tables the user has access to. Then block 144 adds the report element and its specifications in the report meta table and add the report element in the section report hierarchy menu for later direct access.

Referring now to the flow chart of FIG. 14, there is illustrated a flow chart of a sub-routine executed by block 24 of the computer programme of FIG. 4 when creating and modifying a query. Block 146 creates a new query by creating a new data element in the query list and specifies the type of query. This type of query is built by creating a list of queries and/or tables that contain at least one column/attribute of data type date. The result of the tables and queries will be displayed in a calendar presentation.

Once block 146 has completed its operation, then the user through block 147 specifies the default calendar display template for the query and if the query is public or private. The central processor 5 moves to block 148 which displays an empty list of tables and queries that is to be used for the schedule query display. Block 149 then saves the specification of the query and the central processor 5 displays an empty list of participant queries and tables to the schedule query. Then the user through block 149 creates a new data element and selects the table or the query to participate in the schedule query, in this embodiment of the invention only tables and queries containing at least one column/attribute of type date are listed. Then the user specifies via block 150 which column/attribute will be used as the start date and optionally which one will be used as end date. The user can also specify what is the default colour for the items of this table or query. Optionally the user can add a filter to limit the result of the query. The user via block 151 then defines the naming specification of the data element, this is a mandatory step for the query but is optional for the table.

The user through block 152 may add colouring conditions, for example one colour condition reflects a true condition while another colour condition reflects a false condition. The user can add as many colouring conditions as desired. Then block 153 saves the specifications. At this stage the user can return to block 149 which permits the user to add other tables or queries to the schedule query. If the user decides not to add further tables or queries to the schedule query, the user via block 154 then closes the design of the schedule queries.

Referring now to the flow chart of FIG. 15, there is illustrated a flow chart representation of a computer programme executed by block 26 of the computer programme of FIG. 4 for displaying a schedule query page. The user requests to view a schedule type query via block 156. Then block 157 creates a schedule calendar template page containing a calendar view component. Block 158 selects either a table or a query. Block 159 then determines if block 158 selected a table or a query. If block 159 determines that block 158 selected a table, then block 160 fills the table with the relevant data. Once block 160 has completed its operation, the central processor 5 moves to block 158 which selects the next table or query and the central processor 5 moves to block 161 which is described below.

However if block 159 determines that block 158 selected a query, then block 162 generates a query and fills the query. The operation of block 161 will now be described, the central processor 5 prompts the user for a start date and optionally an end date. The central processor 5 also prompts the user to change the default calendar view. The user enters the desired values. The central processor 5 creates a calendar page template containing a calendar view item.

Block 163 then selects a table or query. Then block 164 selects a row of the selected table or query. Block 165 then determines if the row is visible in a display calendar view. If block 165 determines that the row is not visible, the central processor 5 then returns to block 164 which selects the next row of the selected table or query and the process continues from block 164. However, if block 165 determines that the row is visible in the display calendar view, then block 166 displays the data element in the calendar view at the start date and is extended to the end date if the end date is specified. Block 166 displays the data elements using default or override data element naming specifications. In this embodiment of the invention, block 166 displays the data elements using the default colour or evaluates the colouring conditions if the user has specified colouring conditions in the order specified until a colour condition is true. If it is determined that one colouring condition is true, the central processor 5 will use that colour otherwise it will use the default colour condition. Once block 166 has completed its operation, block 167 adds a fifteenth user interface element for the item to let the user drill down to the detail view of the data element if the data element is a table, and creates a query dynamic user interface 1 to let the user drill down to any of the data element details referenced directly or indirectly in the query data element. Then the central processor 5 moves to block 164 which selects the next row of the selected table or query. Once all the rows of the selected table or query have been stepped through, block 168 displays the schedule query page and data element to the user interface display.

Referring now to the flow chart of FIG. 16, there is illustrated a flow chart representation of a sub-routine executed by block 22 of the computer programme of FIG. 4, block 68 of FIG. 7 and block 86 of FIG. 8 for building a data driven visibility filter for retrieving data from a table. Data driven visibility means that data from a table/query is retrieved through a filter which ensures that a user can only see information that the user is authorised to see in accordance with the user's profile. For example, a managing director user's profile may permit access to all the information in the data repository, while a sales person user's profile may permit access that is limited to information relating to sales. Thus, the dynamic user interface 1 of the managing director and of the sales person will look and function differently even though they interface with the same data repository. The data driven visibility filter has three ways to filter data. Firstly, records in tables can be linked to a user using a column/attribute of data type user link, the filter will permit access to records that relate directly to the currently logged in user. Secondly, a contact table is built containing a plurality of contacts and the filter will permit a user to link to contacts that are associated with the user's profile. Thirdly, a team table is built for storing teams which define groups of contacts. The user is able to link to one or more contacts associated with the user's profile and hence the filter permits a user to link to all teams that contain any of the contacts that the respective user is associated with through the user's profile.

Block 174 builds an empty table list filter before loading table data from the data repository. Block 175 initiates a recursive process for stepping through each attribute of the table. For each step in the process of block 175, block 176 determines if the attribute is a user link data type and whether it is marked as a data visibility constraint. The data visibility constraint is provided for flagging whether the attribute/relationship is a user link type, a relationship to a contact or a relationship to a team. If block 176 determines that the attribute is not a user link data type marked as a data visibility constraint, the central processor 5 returns to block 175 and steps to the next attribute. However, if block 176 determines that the attribute is an user link data type and is marked as a data visibility constraint, the central processor 5 then moves to block 177 which adds a new condition to the table list filter linking this new condition to existing conditions of the table list filter using ‘OR’ logic unless this is the first condition of the table list filter so that the attribute must equal the current user identifier. In other words, the new condition is cross referenced to the appropriate existing conditions.

Once block 177 has finished its task, the central processor 5 returns to block 175 which steps to the next attribute in the selected table. When the recursive process of block 175 is completed, the central processor 5 moves to block 178 which initiates a recursive process which steps through each relationship of the table. For each step in recursive process of block 178, block 179 determines if the relationship is to a contact table and marked as data driven visibility constraint. If block 179 determines that the relationship is to the contact table and marked as data driven visibility constraint, block 181 adds another condition to the table filter using ‘OR’ logic so that the relationship value is in the list of contact identifiers that the profile of that the current user is attached to. Once block 181 has completed its task, the central processor 5 returns to block 178. However, if block 179 determines that the relationship is not to a contact table and marked as data driven visibility constraint, the central processor 5 then moves to block 180 which determines if the relationship is to the team table and marked as data driven visibility constraint. If the block 180 determines that the relationship is to the team table and marked as data driven visibility constraint, then block 182 adds a further condition to the table list filter using ‘OR’ logic so that the relationship value must be in the list of team identifiers that the current user's profile is attached to. Once block 182 has completed its task, the central processor 5 moves to block 178. When the process of block 178 is complete, the central processor 5 moves to block 183 at this stage with the table list filter is complete.

Block 184 contains blocks 175, 176, 177, 178, 179, 180, 181, 182 and 183 and operates as a function. Each time the function of block 184 is called, the central processor 5 is instructed to execute each block which forms part of block 184 in manner as previously described for returning the data driven visibility filter of the appropriate table as defined in block 183. After the operation of block 183 is complete, the central processor 5 moves to block 185 which initiates a recursive process for stepping through each relationship of the table. For each step in the process of block 185, block 189 calls the function of block 184 for returning the data driven visibility filter for the target table of the current iteration of relationship from block 185. Then the central processor 5 moves to block 186 which determines if the data driven visibility filter returned by block 184 is empty. If block 186 determines that the data driven visibility filter is empty, the central processor 5 returns to block 185 which steps to the next relationship of the table. However, if block 186 determines that data driven visibility filter is not empty, the central processor 5 moves to block 187 which adds the data driven visibility filter to the table list filter of block 174 using ‘AND’ logic. Once block 187 has completed its task, the central processor 5 returns to block 185. When the process of block 185 is complete, the central processor 5 moves to block 188 which generates a SQL query to retrieve the table data according to the table list filter constraints and conditions defined, and executes the SQL query on the data repository to retrieve the table data from the data repository stored on the magnetic disk 2 to the computer 3.

Referring now to FIG. 17, there is illustrated a flow chart representation of a sub-routine for building a data driven visibility filter for retrieving data from a query, the sub-routine is executed by block 22 of the computer programme of FIG. 4, block 105 of FIG. 9, block 97 of FIG. 10, and blocks 160 and 162 of FIG. 15

Block 190 builds an empty query list filter. Then block 191 initiates a recursive process for stepping through each table used in the query structure, in other words, tables used in the query table hierarchy. For each step in the recursive process of block 191, the function of block 184 from FIG. 16 is called for returning the data driven visibility filter for the table iteration from recursive block 191. The central processor 5 then moves to block 192 which determines if the data driven visibility filter returned by block 184 is empty. If block 192 determines that the data driven visibility filter is empty, the central processor 5 returns to block 191. However, if block 192 determines that the data driven visibility filter is not empty, block 193 adds the data driven visibility filter to the query filter using ‘AND’ logic. When block 193 has completed its task the central processor 5 returns to block 191.

When the recursive process of block 191 is complete, the central processor 5 moves to block 194. Block 194 initiates a recursive process for stepping through each relationship which is not used in the query link structure, in other words, the relationship used to build the query table hierarchy. For each step in the process of block 194, block 195 operates in a similar the manner as block 184 of FIG. 16, in this case block 195 returns the relationship target table's data driven visibility filter. Then the central processor 5 moves to block 196 which determines if the target table's data driven visibility filter is empty. If the target table's data driven visibility filter is empty, the central processor 5 return to block 194. However, if block 196 determines that the target table's data driven visibility filter is not empty, the central processor 5 moves to block 197 which adds the target table's data driven visibility filter to the query filter using ‘AND’ logic. When the process of block 194 is complete, the processor moves to block 198 which generates a SQL query to retrieve the query data requested from the data repository according to the defined query filter constraints, and executes the SQL query on the data repository.

The invention is not limited to the embodiment hereinbefore described, which may be varied in construction and detail.

1-32. (canceled)

33. A method for generating a dynamic user interface for facilitating interfacing with an electronic data repository in which a collection of data elements is stored, the method comprising extracting meta data from an existing data model describing the data elements stored in the data repository, processing the extracted meta data in accordance with a predefined set of rules to generate a meta model, and generating the dynamic user interface based on the meta model.

34. A method as claimed in claim 33 in which the set of rules comprises instructions for tabulating the extracted meta data and storing the tabulated extracted meta data.

35. A method as claimed in claim 33 in which the meta model comprises definitions for producing a visually perceptible representation thereof for displaying on a visual display screen.

36. A method as claimed in claim 33 in which the dynamic user interface is populated with data elements.

37. A method as claimed in claim 33 in which the set of rules comprises instructions for generating a list of identities of tables containing the data elements in the data repository not represented in the data model, and preferably, the set of rules comprises instructions for displaying the list of the identities of tables on a visual display screen for facilitating selection of tables therefrom in response to instructions from a data input device, and advantageously, the meta model is responsive to identities selected from the list of identities of tables, and preferably, the set of rules comprises instructions for generating a meta data description of each table in the data repository corresponding to the identity selected from the list of identities of tables based on an inherent description of the respective table in the data repository, and advantageously, the generated meta data description is incorporated into the meta model for facilitating interfacing with data elements in the data repository not represented in the data model.

38. A method as claimed in claim 33 in which the set of rules comprises instructions for adapting the user interface to permit reading data elements from the data repository.

39. A method as claimed in claim 33 in which the set of rules comprises instructions for adapting the user interface to permit writing data elements to the data repository, and preferably, the meta model represents data elements written to the data repository, and advantageously, the meta model represents new data elements being entered to the data repository.

40. A method as claimed in claim 33 in which the meta model is responsive to the visually perceptible representation being modified.

41. A method as claimed in claim 33 in which the set of rules comprises instructions for defining a query for interrogating the data repository, and preferably, the query is based on the relationships between tables of the data model, and advantageously, the query is translated into a structured query language statement to query the data repository, and preferably, the query relates to tables of more than one data repository the structured query language statement is broken down into sub structured query language statements that target the corresponding data repository.

42. A method as claimed in claim 33 in which the set of rules comprises instructions for creating a communication link for the user interface to the data repository.

43. A method as claimed in claim 42 in which the set of rules comprises instructions for providing a security means associated with the communication link, the security means being responsive to an authorisation code for controlling access to the data elements to the data repository, and preferably, the meta model is indicative of the communication link.

44. A method as claimed in claim 43 in which the meta model is responsive to the authorisation code for defining different levels of access to the data repository.

45. A method as claimed in claim 43 in which the set of rules comprises instructions for defining filters in response to the authorisation code for filtering the data elements in the data repository.

46. A method as claimed in claim 33 in which the set of rules comprises instructions for generating a definition of a hierarchy of tables, and preferably, the set of rules comprises instructions for displaying a hierarchy menu representation of the hierarchy of tables, and advantageously, the dynamic user interface facilitates selection of tables from the hierarchy menu representation.

47. A method as claimed in claim 33 in which the data model is defined by a software application associated with the data repository.

48. A method as claimed in claim 33 characterised in that the set of rules is stored on a readable storage medium.

49. A computer programme product directly loadable into the internal memory of a computer, comprising software code portions for performing the method as claimed in claim 33.

50. A computer programme product stored on a computer usable medium, comprising a computer readable programme means for causing a computer to perform the method as claimed in claim 33.

51. A computer readable medium, having a programme recorded thereon, wherein said programme is for making a computer execute the method as claimed in claim 33.

52. A dynamic user interface for facilitating interfacing with an electronic data repository, the system comprises the data repository in which a collection of data elements is stored, a storage means storing a set of rules being communicable with a computing means for instructing the computing means to operate in a predetermined manner, a means for creating a communication link between the computing means and the data repository for communicating data over the communication link, an extracting means for extracting meta data from an existing data model describing the data elements in the data repository, a processing means for processing the extracted meta data in accordance with a predefined set of rules to generate a meta model, a generating means for generating the dynamic user interface based on the meta model.
